(19) United States
(12) Patent Application Publication
(10) Pub. No.: US 2011/0014008 A1
(43) Pub. Date: Jan. 20, 2011

(54) DOWEL, PARTICULARLY ONE TO ALLOW A SLEEPER SCREW USED TO ATTACH A RAILWAY RAIL TO BE SCREWED INTO A RAILWAY SLEEPER

(76) Inventor: Edmond Mahikian, Bourg-En-Bresse (FR)

Correspondence Address: DEFILLO & ASSOCIATES, INC., P.O. Box 14104, Clearwater, FL, 33766, US

(21) Appl. No.: 12/933,942

(22) PCT Filed: Mar. 25, 2009
(86) PCT No.: PCT/IB2009/051238

§ 371 Date: Sep. 22, 2010

Related U.S. Application Data
(62) Division of application No. 61/048,565, filed on Apr. 29, 2008.

(30) Foreign Application Priority Data
Apr. 1, 2008 (FR) 0801720

(51) Int. Cl. E01B 9/62; B23P 19/00

(52) U.S. Cl. 411/432; 29/428

(57) ABSTRACT

Dowel allowing a fastener to be fitted into a wall, particularly allowing a sleeper screw used to secure a railway rail to be screwed into a railway sleeper. The dowel including an internal screw thread intended to mate with the screw thread of the fastener, and containing a compressible element resting against the end wall of the dowel. The compressible element in the undeformed state having a height at least equal to one third of the height of the dowel.

### CROSS REFERENCE TO RELATED APPLICATION

This application is a national stage entry of PCT/IB2009/051238 filed Mar. 25, 2009, under the International Convention.

### FIELD OF THE INVENTION

The present invention concerns a dowel allowing a fastener to be fitted into a wall, particularly to allow a sleeper screw used to attach a railway rail to be screwed into a railway sleeper. The invention also concerns method for producing said dowel.

### BACKGROUND TO THE INVENTION

It is well known to fasten a railway rail to a railway sleeper using a sleeper screw, the sleeper screw being screwed into a dowel integral with the sleeper. The dowel is generally made from a synthetic material and comprises a screw thread capable of cooperating with the thread of the sleeper screw.

One problem that exists with this type of dowel is the risk of introduction in the dowel of a foreign body (gravel or surface water) during the period of time separating the installation of the sleeper and the placement of the sleeper screw. This foreign body can, during fitting of the sleeper screw, lead to cracking, or even bursting of the wood or concrete forming the sleeper.

A similar problem is that of the insertion of surface water in the bottom of a dowel after placement of the sleeper screw; the volume of this water increases when it freezes and can also lead to deterioration of the lower portion of the dowel and the surrounding area of the sleeper.

To resolve this problem, French patent application no. 2 840 928, in the applicant's name, proposed placing, in the bottom of the dowel, a short compressible element, in the form of a capsule made of deformable material that is inwardly hollow. The capsule can have a peripheral skirt ensuring its maintenance in the dowel by slight wedging.

This capsule is of limited effectiveness, however, regarding either of the aforementioned problems.

Document EP 1 116 826 describes a similar compressible element.

### SUMMARY OF THE INVENTION

The aim of the present invention is to resolve these problems, which are essential in practice and have been experienced for some time.

The concerned dowel comprises, in a known manner, an inner screw thread designed to cooperate with the screw thread of the fastener, and contains a compressible element resting against the bottom of the dowel.

According to the invention, the compressible element in the undeformed state has a height at least equal to one third of the dowel height.

The inventor in fact observed that the aforementioned problems resulted, with the capsule according to the prior art, not only from an insufficient volume of the capsule in case of significant volume of one or several rigid foreign bodies such as one or several pieces of gravel, but also, when this foreign body is water as is the case most of the time, trapping of a substantial portion of said water by the sleeper screw itself upon screwing in thereof. Indeed, the inventor noticed that at the beginning of insertion of the sleeper screw into the dowel, some of the remaining water was able to escape under pressure via the gap existing between the screw thread of the sleeper screw and the screw thread of the dowel but that, as the insertion was done, this exit occurred in increasingly small quantities.

It is in this way that the inventor realized that with a compressible element occupying a significant portion of the height of the dowel, or even the entire height, the compressible element would simultaneously have:

a sufficient volume to form a compressibility reserve sufficient even in case of a significant volume of one or several rigid foreign bodies, such as one or several pieces of gravel;

a height allowing said compressible element to eliminate or greatly limit the amount of surface water that may be present in the dowel when the sleeper screw is screwed in; this height makes it possible for nearly all of said surface water to escape under pressure at the beginning of insertion of the sleeper screw in the dowel, thereby eliminating any trapping of a substantial quantity of water in the bottom of the dowel, and

an upper face in contact with the lower end of the sleeper screw after complete screwing in of said sleeper screw, eliminating any substantial empty volume in the bottom of the dowel after said screwing in.

The result is that the dowel according to the invention is effective even in the case of a significant volume of rigid foreign bodies.

Moreover, with this dowel, the surface water present in the dowel can be almost completely eliminated during insertion of the sleeper screw, eliminating the risk of trapping the water and, as a result, creating, immediately or with a delay, cracking or even bursting of the sleeper.

Moreover, the sleeper screw will bear against the compressible element and compress it during its screwing in, such that the upper face of said compressible element is in contact with the lower end of the sleeper screw after complete placement thereof. Any substantial volume is thus eliminated in the bottom of the dowel, consequently eliminating the risk of water accumulation in the bottom of said dowel, capable of freezing and therefore deteriorating the dowel and the sleeper when its volume increases.

The compressible element can extend between the bottom of the dowel and the upper end of the screw thread of the dowel, in which case the compressible element can be slightly compressed to be able to limit the screwing of the fastener. This compressible element can also extend between the bottom of the dowel and a level situated pulled back from the upper end of the screw thread of the dowel, over a distance such that a few turns of the screw thread are left free. The screwing of the sleeper screw can thus be initiated without the compressible element having to be compressed, and therefore does not constitute any obstacle to said screwing.

The compressible element can assume any shape or structure, in particular the form of an inwardly hollow capsule. Preferably, this compressible element is made of a closed-cell cellular material, such as an expanded polystyrene, a polyethylene foam or a polyurethane foam. The compressible element can thus be compressed completely controllably and does not risk interfering with the screw thread of the dowel and fastener during its compression.

The compressible element can in particular assume the form of a cylinder.

It can have a diameter slightly larger than the diameter of the cavity of the dowel, to be able to be engaged in said cavity with friction. This compressible element is thus kept in this cavity by said friction.

A method for manufacturing the dowel according to the invention comprises the following steps:
forming said compressible element according to a cylindrical shape, and
engaging said compressible element in the dowel to the bottom of said dowel.

Another method for manufacturing the dowel according to the invention comprises the following step:
injecting an expanding material in the bottom of the dowel.

### BRIEF DESCRIPTION OF THE FIGURES

The invention will be well understood, and other features and advantages thereof will appear, in reference to the appended diagrammatic drawing, showing, as a non-limiting example, one preferred embodiment of the dowel it concerns.

FIG. 1 is a longitudinal cross-sectional view of said dowel, a sleeper screw intended to screwed into the dowel, and a compressible element; and

FIGS. 2 to 4 are views of these three parts, similar to FIG. 1, during three successive screwing in positions of the sleeper screw in the dowel.

### DETAILED DESCRIPTION OF THE FIGURES

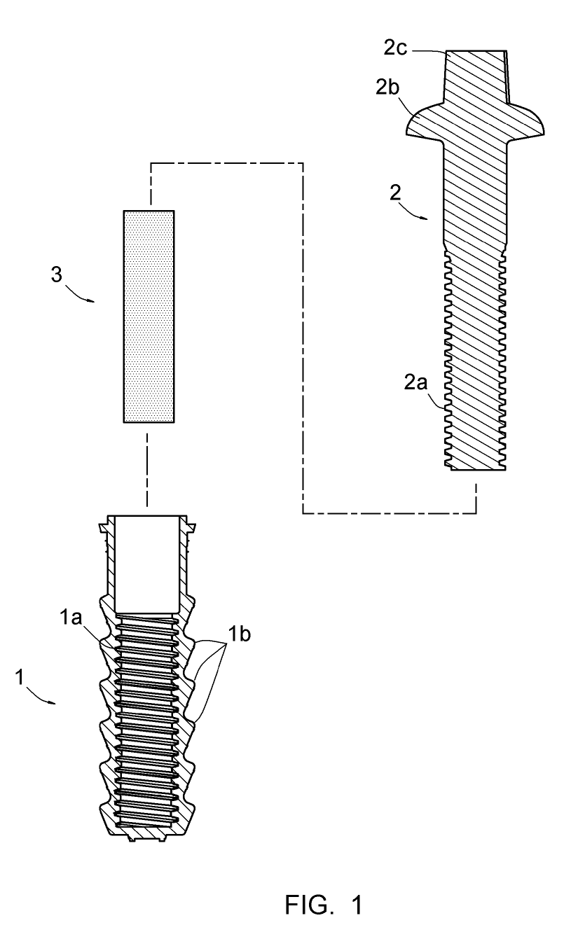

FIG. 1 illustrates a dowel 1 allowing the screwing of a fastening sleeper screw 2 of a railway rail into a railway sleeper.

The dowel 1 is made of a synthetic material and inwardly comprises a screw thread 1a intended to cooperate with the screw thread 2a of the sleeper screw 2. On its outer face, it comprises a series of circular protrusions 1b allowing it to be anchored in the wood or concrete making up the sleeper.

The sleeper screw 2 comprises, aside from the screw thread 2a, a skirt 2b allowing the fastening of a rail and a square maneuvering rivet 2c.

The dowel 1 and the sleeper screw 2 are of the traditional type and are well known in themselves, such that they will not be described in more detail.

The dowel 1 is intended to contain an element 3 made of a compressible material, in particular an expanded polystyrene, polyethylene foam or polyurethane foam. In the illustrated example, this compressible element 3 is in the form of a cylinder whereof the diameter is slightly smaller than the inner diameter of the dowel 1, this cylinder 3 being intended to be inserted into the dowel 1 until it rests on the bottom thereof, and to be fastened to said dowel using any suitable means, in particular by sticking.

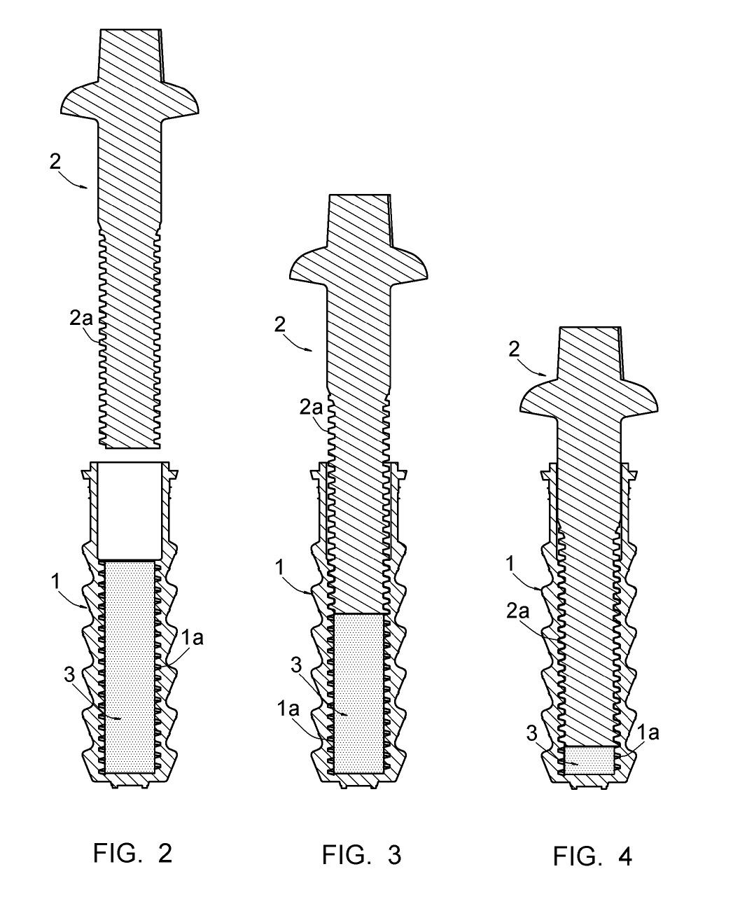

In reference to FIG. 2, it appears that before placement of the sleeper screw 2 in the dowel 1, the compressible element 3 has a height such that its upper end is at the level of the upper end of the screw thread 1a of the dowel 1.

When the sleeper screw 2 is screwed in, the sleeper screw 2 is pressed against the compressible element 3 and is screwed so as to make its screw thread engage with the screw thread of the dowel 1. The compressible element 3 gives before the sleeper screw during this screwing, compressing longitudinally under the pressure exerted by the sleeper screw 2 (cf. FIG. 3). This compression continues until the sleeper screw 2 is completely engaged in the dowel 1 (cf. FIG. 4); in this position, the upper end of the compressible member 3 is in the immediate vicinity of the lower end of the sleeper screw 2, such that there is no substantial free space at the bottom of the dowel 1.

Thus, before screwing in of the sleeper screw 2, the element 3 occupies a significant portion of the height of the dowel 1, such that it makes it possible to relatively easily remove one or several pieces of gravel that may fall into the volume of the dowel 1 remaining free; in any case, it forms a sufficient compressibility reserve to absorb the volume of one or several pieces of gravel or other rigid foreign bodies likely to be present in the dowel 1.

Moreover, the height of the element 3 allows said element to limit the amount of surface water that may be present in the dowel 1 during screwing in of the sleeper screw 2 and to keep that water in a raised position in the dowel; this quantity limitation and raising make it possible for nearly all of the surface water to escape under pressure at the beginning of insertion of the sleeper screw 2 in the dowel, thereby eliminating any trapping of that water in the bottom of the dowel 1, and therefore any compression of said water at said bottom.

Moreover, the height of the element 3 and the progressive compression of said element 3 during screwing of the sleeper screw 2 make it possible for the upper face of the element 3 to be in contact with the lower end of the sleeper screw 2 after complete screwing in of said sleeper screw 2. Any substantial empty volume in the bottom of the dowel 1 is thus eliminated after said screwing in, as shown in FIG. 4.

The invention consequently provides an anchoring dowel 1 with a compressible element 3 making it possible to resolve the limited effectiveness of similar dowels of the prior art regarding the problem of cracking, or even bursting, of the wood or concrete making up the sleeper during screwing in of a sleeper screw 2.

The invention was described above in reference to an embodiment provided purely as an example. It goes without saying that it is not limited to these embodiments, but that it extends to all embodiments covered by the appended claims.

1- A dowel for allowing a fastener to be fitted into a wall, particularly to allow a sleeper screw used to attach a railway rail to be screwed into a railway sleeper, the dowel comprising:
an inner screw thread designed to cooperate with the screw thread of the fastener, and
containing a compressible element resting against the bottom of the dowel;
wherein the compressible element in the undeformed state has a height at least equal to one third of the dowel height.

2- The dowel according to claim 1, wherein the compressible element extends between the bottom of the dowel and a level situated pulled back from the upper end of the screw thread of the dowel, over a distance such that a few turns of the screw thread are left free.

3- The dowel according to claim 1, wherein the compressible element is made of a closed-cell cellular material, such as an expanded polystyrene, a polyethylene foam or a polyurethane foam.

4- The dowel according to claim 3, wherein the compressible element assumes the form of a cylinder.

5- The dowel according to claim 1, wherein the compressible element has a diameter slightly larger than the diameter of the cavity of the dowel, to be able to be engaged in said cavity with friction.

6- A method for manufacturing the dowel according to claim 1, comprising the following steps:
forming said compressible element according to a cylindrical shape, and
engaging said compressible element in the dowel to the bottom of said dowel.

7- The method for manufacturing the dowel according to claim 6, comprising the following step:
injecting an expanding material in the bottom of the dowel.
